(19) United States
(12) Patent Application Publication
(10) Pub. No.: US 2025/0148491 A1
(43) Pub. Date: May 8, 2025

(54) METHOD AND SYSTEM FOR MANAGING COUPON AND PROVIDING COUPON-BASED TARGETED ADVERTISEMENT BY USING ARTIFICIAL INTELLIGENCE

(71) Applicant: SK Planet Co., Ltd., Seongnam-si (KR)

(72) Inventor: Sunghyun YOON, Seoul (KR)

(21) Appl. No.: 18/763,709

(22) Filed: Jul. 3, 2024

(30) Foreign Application Priority Data
Nov. 7, 2023 (KR) 10-2023-0152722
Nov. 9, 2023 (KR) 10-2023-0154175

(51) Int. Cl. G06Q 30/0207; G06Q 30/0251

(52) U.S. Cl. CPC G06Q 30/0207; G06Q 30/0251

(57) ABSTRACT

Embodiments relate to utilizing artificial intelligence (AI) technology to enable comprehensive and systematic management of coupons that can be equivalent to marketing strategies or benefits. A first analysis on a raw data stored as text, image, video, or any combination thereof in the IT device is performed with an AI tool to automatically detect one or more coupons from the raw data. The result of the first analysis is treated as the detected coupons that will be stored in a coupon database or a local memory. A second analysis on the coupon database or local memory is performed with the AI tool to extract a detailed coupon information from each of the detected coupons. The detailed coupon information corresponding to each of the detected coupons is clustered based on one or more predetermined criteria and stored as the clustered result in the coupon database or local memory.

### CROSS REFERENCE TO RELATED APPLICATIONS

This application claims the benefits of Korean Patent Applications No. 10-2023-0152722, filed on Nov. 7, 2023, and No. 10-2023-0154175, filed on Nov. 9, 2023, which are hereby incorporated by reference in their entirety into this application.

### BACKGROUND

### 1. Field of the Invention

This disclosure generally relates to a system, method, and computer-readable storage medium enabling an efficient and integrated management of multiple coupons with various use conditions, expiration dates, etc. at a consumer's information technology (IT) device by using the artificial intelligence (AI) technologies. In the meantime, this disclosure also generally relates to an AI system, method, and computer-readable storage medium enabling advertisers to effectively analyze usage details of such various multiple coupons and apply such analysis results to their targeted advertisements.

### 2. Description of the Related Art

Targeted advertisement refers to advertising strategies performed by associating the trait information of potential consumers with products or services that an advertiser wants to promote or market. For example, in a case where a consumer Z accessing a search engine provider X visited a particular website Y (which is also an advertiser), a manager of the search engine provider X may become aware of the web browsing history or internet protocol (IP) address of the consumer Z. Thus, a marketing strategy has come from an understanding that advertising performances might be improved if the search engine provider X that accepted advertising requests from the advertiser Y may target the consumer Z and expose advertising materials of the advertiser Y to the consumer Z. Such targeted advertising has become a very important marketing tool especially for online advertisements based on a presumption that the potential consumer Z would be likely to revisit the particular website Y to purchase the advertised product after the consumer Z has been exposed to the advertiser Y's advertisements. In other words, regardless of specific reasons for the consumer Z to have visited the website of the advertiser Y, the advertising exposure of Y's advertisements to the consumer Z will be presumed to improve the advertising performance. In this exemplary scenario, the search engine provider X plays a role of an advertising agency with Y's advertising request involving Y's payment of advertising fees to X, in Y's hope that X would be able to effectively perform targeted advertising.

However, targeted advertising is not limited to the above-described search engine settings. As long as there are enough potential consumer users, any platform such as IP TV, smartphone apps, or social media websites may be utilized for the purpose of targeted advertising.

For instance, IP TV providers may be aware of watch histories of their customers, app developers may have information on their app users' personal traits to understand overall characteristics of the smartphone users who are using their apps, or social media platform companies may track user activities such as user postings or friending/following. Therefore, advertisers can use IP TV, apps, social media, etc. as their digital advertising platform, as if they are posting ads on magazines or newspapers.

As the smartphone penetration rate increases and wired/wireless network infrastructure develops worldwide, detailed ways of the targeted advertising became diversified. Among other things, advertisements with targeted coupons may be easily seen in our daily lives. For example, when a seller of home appliances is able to secure the panel data regarding users' purchase history or buying activities of the home appliance product, such seller may provide targeted coupons with remarkable accuracy to consumers who are highly likely to purchase the seller's product.

To explain about a coupon in more detail, its traditional meaning is a statement of due interest to be cut from a bearer bond when payable and presented for payment. However, in recent years, its meaning has expanded to (i) a small piece of document (including a paper, electronic image, any computer-readable document, etc.) that allows one to get a service or product for free or at a lower price; (ii) a ticket or form authorizing purchases of particular items such as rationed commodities; (iii) a certificate or similar evidence of a purchase redeemable in premiums; or (iv) a part of a printed or electronic advertisement or marketing tool to be cut off to use as an order blank or computer-readable inquiry form or to obtain a discount on merchandise or services, regardless of whether the coupon is used in online or offline transactions.

As IT devices such as smartphones, smart pads, notebooks (including small and light laptops), etc. having various functions and usages are widely spread together with wired or wireless communication infrastructure enabling stable network access for these devices, coupons now became one of the most important marketing strategies in almost all transactions including the e-commerce. Customers can now easily enjoy purchase rewards with better prices or premiums than those without using coupons, while the coupon publishers such as online shops, department stores, hotels, or airline companies may provide coupons or e-coupons based on the customers' phone numbers or via particular apps.

Meanwhile, there are marketing tools designed similarly to the above-described coupons. For example, there are some differences between a gift card and a coupon, both can be understood as marketing tools in general. The gift card is a card entitling the recipient to receive goods or services of a specified value from the issuer, published in the form of unsigned and prepaid e-certificate in many cases. In some cases, such gift card might be used for predetermined products or services. In other cases, the gift card might be used at particular businesses such as online or offline stores or shopping centers.

Customer loyalty program may be another example of such marketing tool. To establish a continuing and positive relationship between a product seller or service provider and a client, many programs offering premium benefits to the client based on the client's membership or membership points are currently available, which again are not so different from the coupon marketing. It would not be unnatural even if these various marketing strategies are embraced as a sort of targeted coupon advertising strategy in this invention.

Now it is evident that many companies in various fields of industries, such as airlines, apparels, groceries, etc., try to increase their sales revenues with proper margins by adopting the above-described coupon marketing, including coupon campaigns. Furthermore, the targeted coupon-publishing strategy designed for targeted clients may contribute not only to improving short-term sales, but also to acquiring so-called customer lifetime value (CLTV or CLV) as an important mid or long-term marketing means for sellers. In other words, as long as sellers that provide services or products may make successful acquisitions of customers thanks to the coupons, even if the immediate sales increase by virtue of coupons campaigns might not be satisfactory in comparison to the short-term advertising expenditures, the sellers still can enjoy mid or long-term benefits in terms of CLTV because they might expect persistent repurchases from their clients.

However, current coupon marketing schemes including the coupon advertising have several problems, which may be briefly understood from the seller (that is, the publisher of coupons) side and the customer side. On one hand, the seller, which would be a publisher of coupons, might not ignore low conversion rate (CVR). To explain CVR with an example, the CVR would be three percent in a case where the seller published one hundred coupons but only three of them were actually used for sales. Unfortunately, in reality, many companies end up with publishing more coupons to make up for such low CVR in spite of the increasing expenditure for marketing and advertising.

On the other hand, consumers, for instance, might not often figure out which coupon among so many coupons stored in their smartphones is the most useful one for them. That is, when too many and so different types of coupons have been provided to a single consumer, the potential consumer may ignore most of the numerous coupons as a kind of spam mail even if such ignored coupons might turn out to be what the consumer looked for. To be worse, in many cases, each of coupons published even by a single seller may have its unique usage-eligibility requirement such as the coupon holder's sex, age, previous purchase history, etc., and specifically-designed terms and conditions such as the coupon's valid period, applicable products or services, discount rate, applicability of double discounts. Considering the above, it is highly likely that coupons themselves are merely burdensome collection of difficult and complex information which cannot be easily managed in consumers' perspectives.

In particular, consumers who want to enjoy benefits of coupons, gift cards or vouchers, membership premium, etc. might have to inevitably suffer from a side effect in that they should handle more and more heterogeneous information by using their IT devices such as smartphones. Such side effect might not be resolved even when the consumers can utilize benefits from the targeted advertising. For example, each individual consumer might not be able to perfectly manage different usage conditions or valid periods of discount coupons for food delivery services or coffee gift cards that he or she recently acquired from friends or marketing campaigns, while such individual is already having a hard time in memorizing or recording available airline mileages, mileage usage conditions, or mileage expiration dates of various airline companies that she or he bought will buy flight tickets from.

Such side effects for consumers' managing targeted coupons might be a bit relieved by using alert settings of cellphone messages or smartphone apps, or by using automatic coupon-use functions available for several apps, but this might not be a fundamental solution. Ironically, as various consumer benefits become available with better quality, consumers themselves might not fully enjoy such diverse benefits due to the heterogeneity of the consumer-benefit programs in the name of vouchers, gift cards, or membership premiums in spite of consumers' not being able to, after all, differentiate those consumer-benefit programs as the same or similar marketing tools.

Moreover, the targeted advertising should overcome the privacy issues. That is, consumers feel humiliated or concerned about the fact that their online activities such as their watching history of IP TV, their posting history or friending/unfriending status in a social network service (SNS), and their gaming history and app-download history might be the tracking target by someone else. Those humiliating feelings or concerns can be regarded as the issue of privacy and human rights in addition to a mere emotional problem of some individuals. Of course, targeted advertising would be based on the consumers' consent to third party's handling of their personal information. Notwithstanding, for example, when consumers receive so many coupons which turned out to be unnecessary to them, the consumers still may feel burdened with targeted advertising, and in some cases, they may want to aggressively withdraw their previous privacy consent.

On the other hand, if the targeted advertising turned out to be very useful and profitable for some consumers, those consumers might want to receive targeted coupons more and more with positive perspectives on the targeted advertising, rather than having negative or burdensome feelings on their privacy consent.

In short, to properly utilize digital coupons as a marketing tool, the coupon users need to have an efficient and comprehensive way to manage various coupons with, for example, different use terms or valid periods on their IT devices. Furthermore, among other things as for the online advertising with targeted coupons, it is highly required to achieve a precise targeting so that the consumers may focusing on enjoying the targeted promotion benefits rather than having the feeling of rejection regarding the privacy consent.

### SUMMARY OF THE INVENTION

As described above, consumers may not fully enjoy the marketing benefits while sellers may not achieve sales increase that would be satisfactory in comparison to the sellers' marketing expenditures, because consumers do not have a proper tool to handle coupons, gift cards, membership programs, customer loyalty campaigns, or other similar online or offline marketing benefits. Moreover, the CVR of targeted e-coupon advertising still remains relatively low although such targeted advertising has become one of the most important marketing tools in the modern society. There is another problem that an improper targeting might incur consumer privacy issues.

The present invention first aims to provide an efficient and comprehensive solution for a consumer to be able to manage heterogeneous coupons with different use conditions, valid periods, etc. on his or her IT devices, so that the digital coupon can be properly utilized as a marketing tool. Second, the present invention also aims to provide a way for an advertising agency to improve the preciseness of target marketing by using the AI technology, considering that the advertising agency should be one of the major components in digital target-advertising system, together with the advertiser and the consumer.

For reference, the technical aspects of the present invention do not need to be limited to online coupons that can be easily accessible by smartphones. As describe above, the meaning of a coupon now embraces the following multiple meanings: (i) a small piece of document (including a paper, electronic image, any computer-readable document, etc.) that allows one to get a service or product for free or at a lower price; (ii) a ticket or form authorizing purchases of particular items such as rationed commodities; (iii) a certificate or similar evidence of a purchase redeemable in premiums; or (iv) a part of a printed or electronic advertisement or marketing tool to be cut off to use as an order blank or computer-readable inquiry form or to obtain a discount on merchandise or services, regardless of whether the coupon is used in online or offline transactions. After all, the above-described membership benefits or customer loyalty program, gift cards, prepaid paper/electronic vouchers, etc. can be regarded as sort of marketing tools for providing a customer benefit just like the coupon. Therefore, all types of marketing tools might be considered when implementing the present invention. In other words, solutions provided by the present invention should not be confined based on the naming or labeling of particular marketing benefit regardless of whether such benefit is provided in the e-commerce or offline transactions. Hence, in the present invention including the drawings, descriptions, and claims, a “coupon” should be defined to incorporate all the online or offline marketing tools unless there is a specific reason to use terms like digital coupons or online coupons.

It should also be noted that the present invention is not solely intended to address e-commerce situations to be experienced by the personal computer (PC). Thus, in the present invention, the terminology of “computer” or “IT device” may embrace comprehensive meaning to indicate electronic devices such as a smartphone, smart pad, smart watch, notebook, PC, and the like, regardless of the specific naming, labeling, or category of such notebook, smartphone, smart pad, or smart watch.

The present invention aims to address all or at least some of the above-described problems. In short, the present invention suggests a solution utilizing AI technology to enable comprehensive and systematic management of coupons that can be equivalent to any or all of the aforementioned marketing strategies or benefits.

More specifically, the present invention is a computer-implemented method for managing multiple coupons by an IT device. A first analysis on a raw data stored as text, image, video, or any combination thereof in the IT device is performed with an AI tool to automatically detect one or more coupons from the raw data. The result of the first analysis is treated as the detected coupons that will be stored in a coupon database or a local memory. A second analysis on the coupon database or local memory is performed with the AI tool to extract a detailed coupon information from each of the detected coupons. The detailed coupon information corresponding to each of the detected coupons is clustered based on one or more predetermined criteria and stored as the clustered result in the coupon database or local memory. Finally, the detailed coupon information selected from the clustered result according to a user request of the IT device will be displayed for coupon management.

According to another aspect of the present invention, a computer-implemented method at a server side for managing multiple e-coupons for targeted advertising is disclosed. At the server side, a first step receiving e-coupons, each including a detailed coupon information, for the targeted advertising from one or more advertiser terminals is performed. The next step would be a second step transmitting the received e-coupons to one or more client terminals based on a predetermined coupon-targeting criteria. A third step is performed to collect information on whether the transmitted e-coupons have been used by the client terminals; and coupon use details as for the used e-coupons. A fourth step performing an AI analysis on the detailed coupon information and the coupon use details together with a pre-collected profile information of the client terminals and a fifth step creating a new coupon-targeting criteria other than the predetermined coupon-targeting criteria to reflect a result of the AI analysis for the targeted advertising in the future will be performed afterwards. Then, a sixth step repeating the second to fifth steps after transmitting the received e-coupons to the client terminals based on the new coupon-targeting criteria is included in the present invention.

### BRIEF DESCRIPTION OF THE DRAWINGS

The present invention may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 shows an exemplified e-coupon that may be subject to the AI analysis according to an embodiment of the present invention.

FIG. 2 shows an exemplified SNS posting for marketing purposes which may be subject to the AI analysis according to an embodiment of the present invention.

FIG. 3 shows an exemplified offline marketing coupon that may be found at an offline store and be subject to the AI analysis according to an embodiment of the present invention.

FIG. 4 shows another exemplified e-coupon that may be subject to the AI analysis according to an embodiment of the present invention.

FIG. 5 is an exemplified diagram showing the architecture of AI software that may be used for the coupon analysis according to an embodiment of the present invention.

FIG. 6 is an exemplified system presenting how online or offline coupons may be stored in the coupon server and database through customers' smartphones according to an embodiment of the present invention.

FIG. 7 is an exemplified AI coupon advertisement system according to an embodiment of the present invention.

FIG. 8 is an exemplified and more detailed AI coupon advertisement system according to an embodiment of the present invention.

FIG. 9 is a first exemplified user interface (UI) to show how multiple coupons and their detailed coupon information stored in the coupon database may be displayed to end users, for the purpose of the end users' coupon management according to an embodiment of the present invention.

FIG. 10 is a second exemplified user interface to show how multiple coupons and their detailed coupon information stored in the coupon database may be clustered and then displayed to end users, for the purpose of the end users' coupon management according to an embodiment of the present invention.

FIG. 11 is a third exemplified user interface to show how multiple coupons and their detailed coupon information stored in the coupon database may be clustered and then displayed to end users, for the purpose of the end users' coupon management according to an embodiment of the present invention.

FIG. 12 is an example of a comprehensive user interface according to an embodiment of the present invention, enabling the end users to efficiently manage heterogeneous multiple coupons with various use terms, valid periods, etc. on the end users' IT devices and computer programs in an integrative way.

FIG. 13 is a first exemplified user interface for advertisers which may be presented to advertisers by the AI coupon advertisement system according to an embodiment of the present invention.

FIG. 14 is a second exemplified user interface for advertisers which may be presented to advertisers by the AI coupon advertisement system according to an embodiment of the present invention.

FIG. 15 is a third exemplified user interface for advertisers which may be presented to advertisers so that they can review and choose e-coupons revised by the AI coupon advertisement system according to an embodiment of the present invention.

FIG. 16 is a fourth exemplified user interface for advertisers which may be presented to advertisers so that they can review and choose location-based e-coupons created by the AI coupon advertisement system according to an embodiment of the present invention.

### DETAILED DESCRIPTION

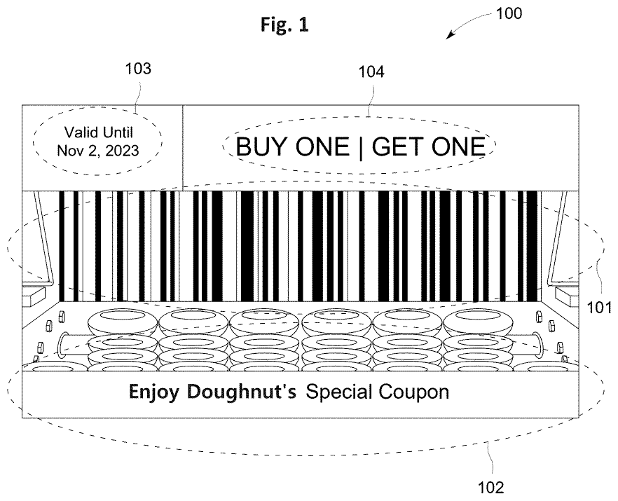

Hereinafter, a preferred embodiment of the present disclosure is described in detail with reference to the accompanying drawings. FIG. 1 to FIG. 4 show various examples of coupons or what can be treated as coupons, for an AI analysis, according to the present invention.

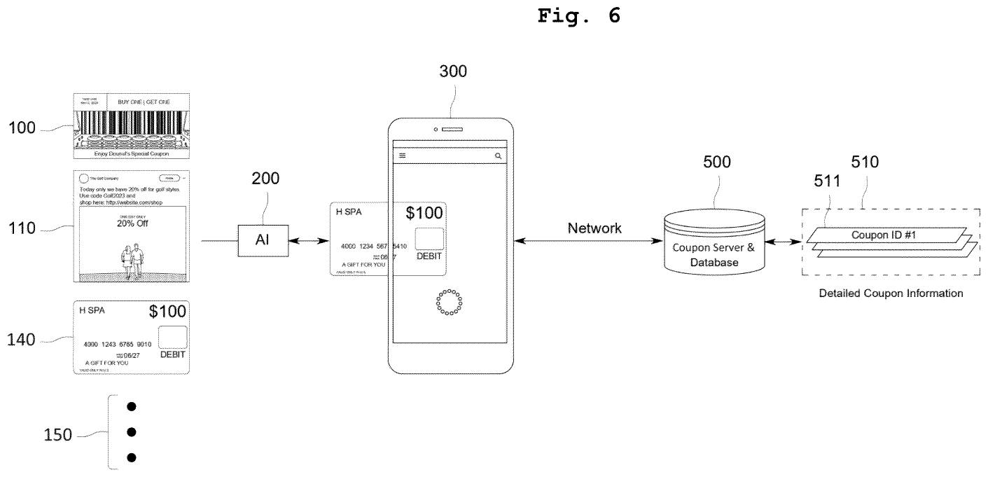

Referring to FIG. 1, it shows an e-coupon 100 downloadable through an app on a consumer's smartphone (for example, smartphone 300 in FIG. 6). The e-coupon 100 may include a barcode 101 as depicted in FIG. 1. Although not shown in FIG. 1, a redemption code or reward code of the e-coupon 100 may be used in place of or together with the barcode 101. In many cases, the e-coupon 100 further includes a marketing text or product image 102 to indicate, for example, what kind of product the e-coupon 100 is about or where the e-coupon 100 can be used. In the example of FIG. 1, the e-coupon 100 can be used at a doughnut store “Enjoy Doughnut.”

The valid period 103 of the e-coupon 100 is indicated by the expiration date as depicted in FIG. 1 although the valid period 103 may sometimes include both the start date (which is not drawn here) and end date. The indication of coupon benefits 104 may be presented in the e-coupon 100 in forms of texts, images, or any combinations thereof to briefly explain the coupon's value in commerce or e-commerce transactions. The barcode 101 or redemption code, product image 102 or coupon information about “where to use,” valid period 103, coupon benefits 104, etc. will be subject to the AI analysis according to one embodiment of the present invention.

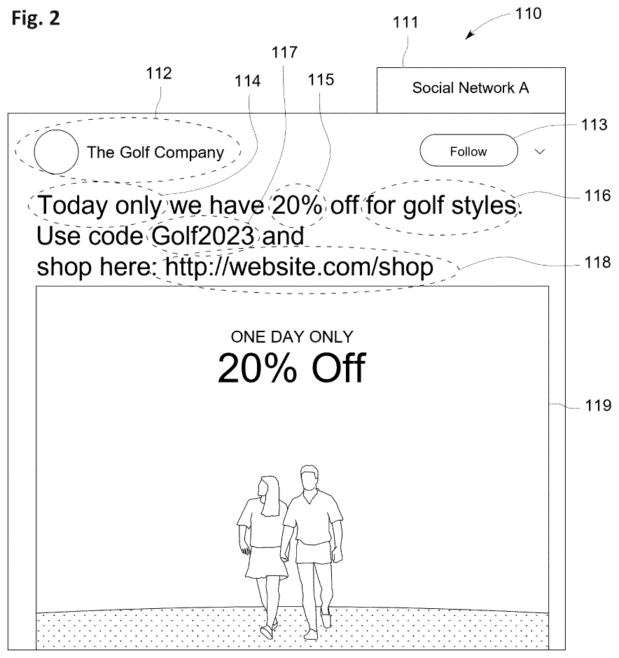

In FIG. 2, an SNS posting 110 is depicted. For example, an advertiser A used its SNS account to upload the SNS posting 110 for marketing purposes in a social network website 111. It should be noted that such SNS posting 110 in FIG. 2 may also be recognized as a coupon according to one embodiment of the present invention. In many cases, the holder 112 of such SNS account may be the same entity with the publisher of coupons who will eventually provide, for example, discount benefits according to the advertisement posting 110. Some users of the social network website 111 might show their interest to receive golf benefits as included in the posting 110 in FIG. 2, by clicking a “like” button (not shown) or “follow” button 113. Other consumer may want to capture the screen of their IT devices (for example, a consumer's smartphone 300 in FIG. 6) to save the current screen with the displayed posting 110 as an image file.

Similarly to the e-coupon in FIG. 1, the SNS posting 110 in FIG. 2 includes valid period 114 (valid only for today according to FIG. 2) and coupon benefits 114 (20% discount according to FIG. 2). In particular, there is an indication of discount-eligible or coupon-applicable products 116, which are golf clothes, in FIG. 2. Furthermore, in FIG. 2, there can be found a coupon number or redeem code “Golf2023” 117 that should be submitted to the seller before enjoying the discount benefit, in lieu of the barcode 101 in FIG. 1, and a website link 118 of the SNS account holder 112 to facilitate its customers' online shopping. The SNS posting 110 in FIG. 2 also includes a marketing summary 119 composed of an image file that abstracts key benefits in a visual way, together with the above-described coupon detailed information such as the valid period (that is, today) of the coupon in FIG. 2 and the indication of eligible products (that is, golf clothes) and discount rate (that is, 20%).

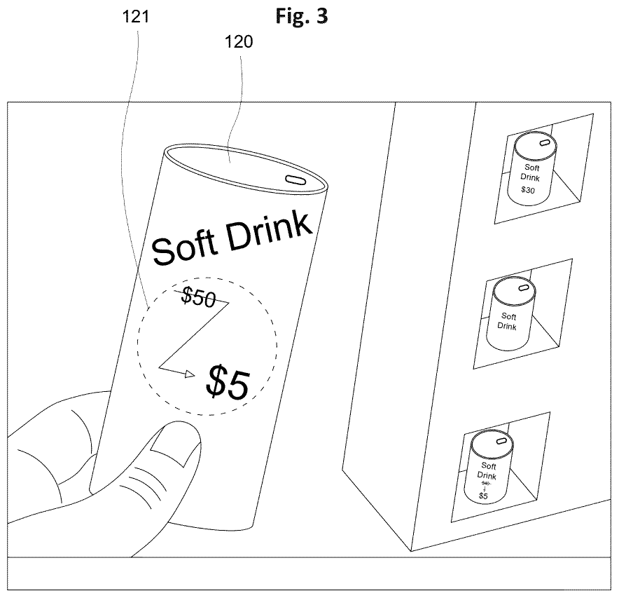

FIG. 3 shows an exemplified offline marketing coupon 121 that may be found at an offline store and be subject to the AI analysis according to one embodiment of the present invention. In short, FIG. 3 depicts a situation where a customer goes to a brick-and-mortar shopping center and picks up an offline product 120 which happens to include a marketing coupon 121 printed on its surface. Such marketing coupon 121 may instantly let the customer know of the marketing benefits (that is, $5 purchase price only for the soft drink, instead of original $50 purchase price in FIG. 3). If the customer takes a picture of the offline product 120 with his or her smartphone 300 with reference to FIG. 6, such offline coupon 121 printed on the offline product 120 now may be subject to the AI analysis in the present invention.

Although not depicted in FIG. 3, there are several augmented-reality or location-based apps that can show, on a real-time basis, various coupon benefits provided by multiple offline stores included in a camera screen of the smartphone 300 or available within a beacon's network coverage. The coupon server and database 500 with reference to FIG. 6 may save those coupon information on the smartphone 300 as a raw data for future AI and coupon analysis.

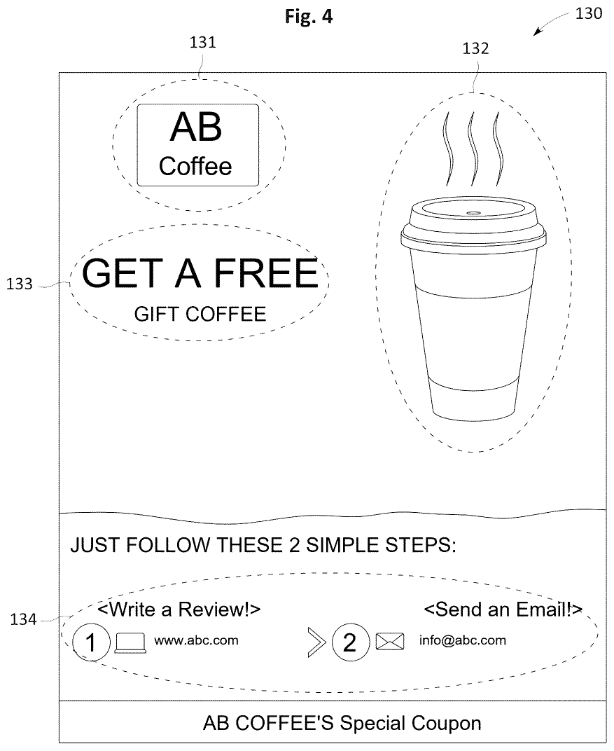

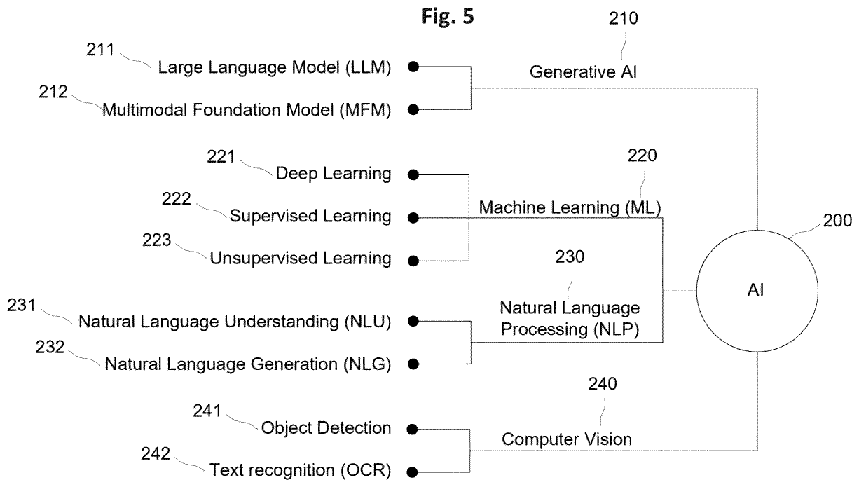

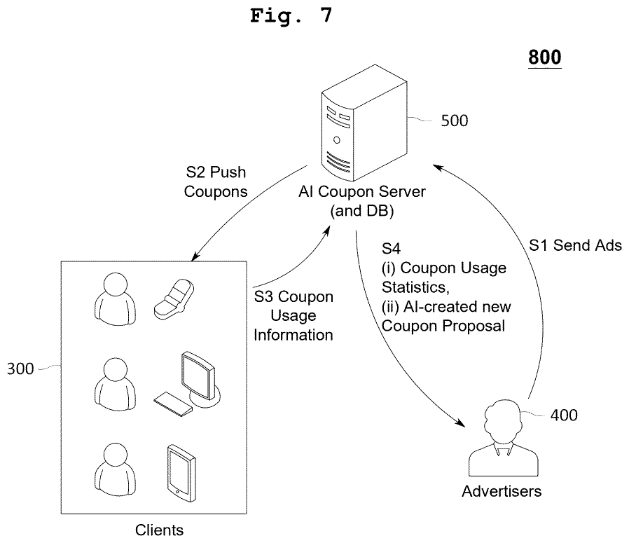

FIG. 4 shows another exemplified e-coupon 130 that may be subject to the AI analysis according to one embodiment of the present invention. As will be described below, coupons in FIG. 1 to FIG. 4 may have been made by and sent from the advertiser terminal 400 to the AI coupon server and database 500 with reference to FIG. 6 and FIG. 7. However, it is also possible in the present invention that those coupons in FIG. 1 to FIG. 4 may be in fact the results, or revised coupons created by an AI (for example, the generative AI 210 depicted in FIG. 5) to propose optimized marketing strategies to the advertiser terminal 400 depicted in FIG. 7.

The e-coupon 130 exemplified in FIG. 4 can be saved in a local memory (not shown) of the smartphone 300 through its camera function, message function, or some available apps. In particular, the e-coupon 130 may include an indication about “where to use” 131 (this might be a coupon publisher, seller, or advertiser. For example, “AB Coffee” shop in FIG. 4) together with a product image 132 for customers' intuitive understanding of which products are applicable for that coupon 130. The e-coupon 130 can be used to get a free coffee as described in the explanation part about coupon benefits 133 of FIG. 4. However, according to another explanation part about coupon use terms 134, such free coffee is available only when the customer accesses the seller's website to write a customer review and send the customer review to the seller or advertiser's email address.

Although not shown in FIG. 4, the terms and conditions for coupon use 134 many include a redemption code to be submitted to a seller's website or a barcode 101 as exemplified in FIG. 1. It should be noted that most e-coupons 130 include some information about the valid period although not depicted in FIG. 4. However, if the advertiser wants to make promotion campaigns on a regular basis to secure customer opinions, there might not be any information about the valid period just like FIG. 4.

As will be described below, if the consumer's smartphone 300 is installed with an AI software 200 in FIG. 4, the smartphone 300 can locally perform the AI analysis on the coupons exemplified in FIG. 1 to FIG. 4 by itself to eventually achieve better results for a precise targeted marketing. To be clear, the meaning of “coupon” as used herein includes the SNS posting 110 for marketing in the social network website 111 as shown in FIG. 2; offline coupons 121 saved in the customer's smartphone 300 as image or video files as shown in FIG. 3; and customer loyalty programs providing membership premiums, as well as the “traditional” e-coupon 130 in FIG. 4.

FIG. 5 is an exemplified diagram showing the architecture of AI software 200 that may be used for the coupon analysis according to one embodiment of the present invention.

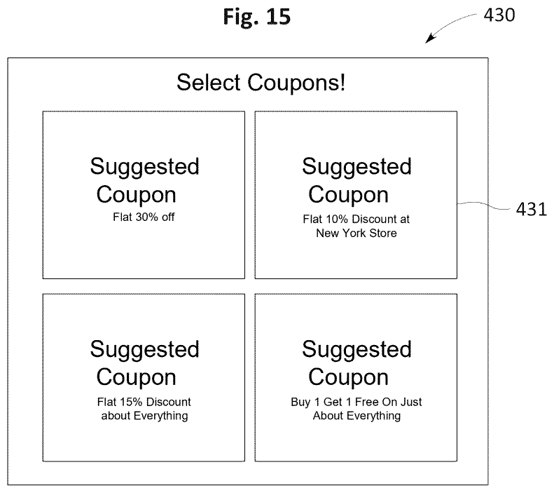

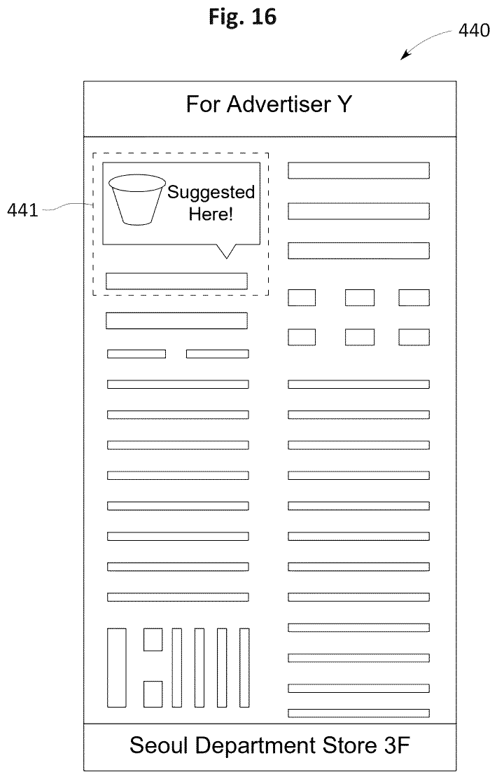

The AI software 200 according to one embodiment of the present invention may preferably include a generative AI tool 210. The generative AI tool 210 creates texts, images, or videos similar to the raw coupon data (which may be, for example, coupons in FIG. 1 to FIG. 4), based on machine learnings about patterns and structures of inputted training data. The generative AI tool 210 may be particularly useful in the present invention because, when the original coupon advertisement (for example, coupons in FIG. 1 to FIG. 4) made by the advertisers 400 themselves does not show satisfactory CVR performances, the AI coupon server and database 500 may generate a new or revised version of such coupon advertisement (for example, revised coupons 431 in FIG. 15 or 441 in FIG. 16) after analyzing how the CVR of the original coupons might be improved. In short, the generative AI tool 210 may have an important role in redesigning new coupons as depicted in FIG. 15 or FIG. 16, after collecting some coupon usage data of the original coupons provided by the advertiser 400 and analyzing which part of the original coupons should be revised for better marketing performances.

That is, the generative AI tool 210 receives as a training data, for example, an e-coupon 100 data in FIG. 1 or FIG. 4 saved in the smartphone 300; screen capture data or document data including the copied and pasted content of the SNS posting 110 in FIG. 2; and video or image data of the offline product 120 and offline coupon 121 acquired by a camera of the smartphone 300 in FIG. 3, and generates a new coupon (for example, coupons in FIG. 15) comprised of text, image, video or any combinations thereof based on the training result about patterns and structures of those received training data. Therefore, although the SNS posting 110 in FIG. 2 or offline coupon 121 printed on an offline product 120 in FIG. 3 is not a traditional paper coupon and is not e-coupons 100, 130 in FIG. 1 or FIG. 4 either, the present invention enables comprehensive management of coupons including marketing promotions provided with various forms as depicted in FIG. 2 or FIG. 3 on the customer's smartphone 300 thanks to the generative AI tool 210.

According to one embodiment of the present invention, the AI software 200 may be implemented in the AI coupon server and database 500 depicted in FIG. 6 and FIG. 7, however, it may also be implemented in the client terminals (that is, for example, IT devices 300 in FIG. 7) under the users' consent to such installation. As for the latter scenario, the AI software 200 may recognize as a set of training data the camera image or video files taken from the offline coupon 121 in FIG. 3 or the SNS posting 110 shown in FIG. 2 as well as those “traditional” e-coupons 100 or 130 saved in the smartphone 300 as shown in FIG. 1 or FIG. 4. In other words, even if some marketing campaigns do not include traditional e-coupons as exemplified in FIG. 2 or FIG. 3, those marketing campaigns may still be applicable to AI analysis of the present invention as long as the AI 200 determines that such marketing campaigns are recognizable as digital marketing coupons.

To improve the performance of the generative AI tool 200, the AI software 200 of the present invention may adopt a large language model (LLM) 211 as a sub-tool to train the AI software 200 with a bulk of sample languages which may be recognized as coupons. As shown in FIG. 1 to FIG. 4, because there are many cases in which a single coupon contains text, image, and even video formats, it is also preferable to adopt multimodal foundation model (MFM) 212 in the generative AI tool 210 for simultaneous AI learning of text, image, and video. When an advertiser 400 is provided with a revised e-coupons as depicted in FIG. 15 or FIG. 16, for example, the original image-type coupon may be completely transformed into an on-line video coupon although not shown in FIG. 1 to FIG. 4.

Referring to FIG. 5, the AI software 200 of the present invention may be comprised of machine learning (ML) tool 220. In this case, a user of the smartphone 300 does not have to review so many photo/image/video files saved in the smartphone 300 to designate individual image files as a coupon one by one. By virtue of the ML tool 220 which is based on statistics algorithms, the AI software 200 of the present invention may, for example, automatically and preliminarily filter particular images as a coupon or a candidate of a coupon.

The ML tool 220 according to one embodiment of the present invention may adopt a deep learning model 221 to analyze given data with multiple partitioned layers.

The ML tool 220 may further use a supervised learning model 222 so that, when uploading a bulk of coupon training data, the detailed coupon information may be obtained as a pre-determined or expected result. That is, the machines do not make inferences without any guidance. The preferable output may be preset as an expected result to become a guidance for the machine learning process.

Of course, the AI software 200 may use an unsupervised learning model 223 by which the accuracy rate in a machine's recognizing the detailed coupon information may be increased after numerous trials and errors of self-mimicking the training data on a neural network, without a need for learning label information in the training data.

The AI software 200 according to one embodiment of the present invention may preferably include a natural language processing (NLP) tool 230. Recently, marketing languages used for coupons include two or more different languages in many cases. Sometimes coupons may include buzzwords which might not be found in a dictionary. Therefore, the NLP tool 230 may be useful in the coupon analysis at the AI coupon server 300 according to the present invention because the NLP tool 230 may analyze texts or language “corpora” based on statistical or probabilistic techniques to process or translate the target languages up to the level of actual human languages.

In the same vein, it would be preferable for the NLP tool 230 to use a natural language understanding (NLU) model 231 in order to let the machine interpret given sentences by using a plurality of rules about lexicon, syntax parser, and grammar.

Sometimes a natural language generation (NLG) model 232 might be more useful in the AI coupon analysis according to one embodiment of the present invention because the NLG model 232 enables language expressions of non-language expressions or of some expressions that did not follow any grammar.

Recent e-commerce transactions by users of smartphones 300, as an example, do not occur in a single specific country in many cases. Therefore, the translation capability of the AI software 200 according to the present invention might be crucial in some cases. For instance, if a Korean traveler planning to visit France uses his or her smartphone 300 and downloads a discount coupon (not shown) provided by an online website of a French museum (not shown), it is possible according to the present invention to perform the AI analysis on the discount coupon written in French by virtue of the NLP tool 230 and even provide marketing insight or feedback to the coupon publisher (that is, the French museum in this scenario) on a cross boarder basis.

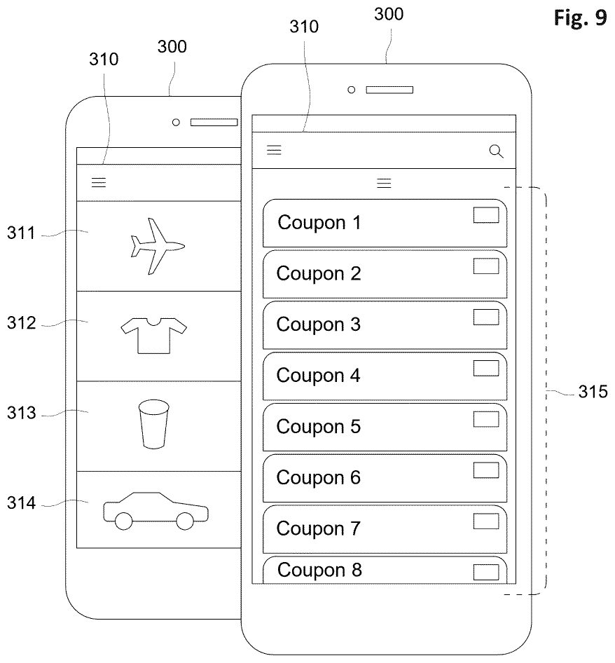

When utilizing these language analysis AI tools 230, 231, 232 as described above, the user interfaces 310, 320, 330, 340, 410, 420, 430, 440 for end customers 300 or advertisers 400 as described with reference to FIG. 9. To FIG. 16, which are provided for the purpose of coupon management, may be convertible into various language versions for those end customers 300 or advertisers 400.

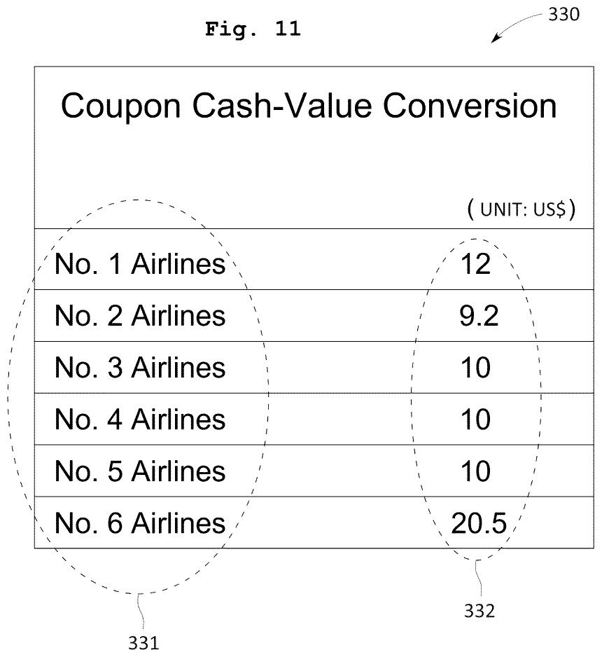

As will be described with reference to FIG. 11 below, as another scenario, a US citizen who has a discount coupon for a foreign museum might wonder how much value the discount coupon has in US dollars. The concept of the detailed coupon information in the present invention reflects such another scenario. To be short, the detailed coupon information can be not only the information written on the coupon itself (for example, such as discount rate of a coupon), but also some derivative information such as coupon-cash exchange value. Thanks to this feature, it is expected in the present invention that the consumers 300 may have very useful coupon management means while the advertisers 400 may have insightful feedback on their coupon advertising to improve their marketing strategies in the future.

Referring back to FIG. 5, the AI software 200 of the present invention may preferably include a computer vision tool 240. As can be seen in FIG. 1, recent e-coupons 100 are made as an image or even a video in many cases. For instance, if the AI software 200 is installed in the user smartphone 300 under his or her consent, whenever the smartphone saves an image or video file relevant to a marketing campaign, the computer vision tool 240 may automatically and instantly extract detailed coupon information such as list of sellers accepting the coupon, valid period, eligible group of consumers who can use the coupon or the like from the image or video file. Therefore, the role of the computer vision tool 240 may eventually improve the coupon analysis performance of the AI coupon server and database 500.

Likewise, it would be preferable that the computer vision tool 240 adopts an object detection model 241 to analyze an image or video including a coupon and non-coupon objects and then effectively filter a relevant portion that can be defined as a coupon from the image or video. As an example, if a consumer suddenly takes the picture of an offline product 120 at a brick-and-mortar store in FIG. 3, such picture may include the product 120 itself, a finger of the consumer, and some irrelevant background scene. The object detection model 241 may be useful in determining which part of the picture should be recognized as a coupon.

Moreover, the computer vision tool 240 may adopt a text recognition model, or optical character recognition (OCR) model 242 especially for a case where the raw data of coupon is, for example, a scanned paper coupon, some hand-written memo related to a coupon, or a picture of a physical gift card (for example, 140 in FIG. 6). The generative AI tool 210 may suggest a revised coupon (for example, 431 in FIG. 15) to an advertiser 400 when the AI coupon server and database 500 extracts some encoded text from such raw data by this OCR model 242 and then inserts new texts instead of original texts into the original coupon.

Before moving on to FIG. 6, it should be clearly noted that the AI software 200 of the present invention differs from commercially available AI tools such as “ChatGPT™.” Although the AI software 200 for coupon analysis may include the generative AI tool 210 as depicted in FIG. 5, the coupon management system of the present invention is not a system in which a user asks coupon-related questions to AI on a chatting window to get some result from, for example, the ChatGPT™. That is, the present invention does not include a “refining” procedure of ChatGPT™ in which the user should optimize his or her question to AI so as to get the most preferable result for the user. Therefore, the AI technology for coupon analysis according to the present invention is not relevant to ChatGPT™.

Also, it would be useful to review some details regarding FIG. 6 to FIG. 8 with reference to FIG. 5 here.

FIG. 6 shows how online or offline coupons 100, 110, 120, 130, 140, 150 may be managed in the coupon server and database 500 through a customer's smartphone 300 according to one embodiment of the present invention.

As explained above, the computer-readable AI software 200 of the present invention is workable on, for example, any IT devices including the coupon server and database 500 as well as a smartphone 300 of a consumer. Thus, the coupon management method of the present invention can be implemented as a stand-alone software in a smartphone 300 to perform all of the AI features in FIG. 5. Also, it is possible to construct a system 800 as in FIG. 7 so that the coupon server and database 500 may perform functions of the AI software 200 in part or as a whole.

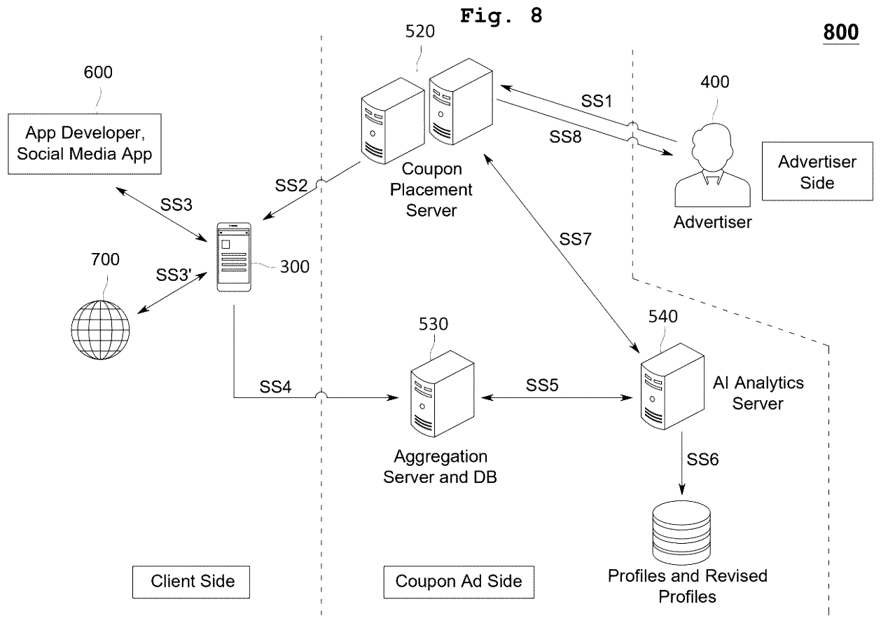

In summary, if the present invention is implemented as a server system 800 as depicted in FIG. 7 and FIG. 8 for AI coupon management, the server system 800 may be comprised of the AI analytics server 540 as shown in FIG. 8, which imports all or some of the raw data stored in a client terminal 300 as texts, images, or any combinations thereof to output the first result of automatic coupon detections done by the AI software 200. The raw data may be files relevant to coupons 100, 110, 120, 130, 140, 150 and detailed information included in those coupons. The server system 800 may further include the coupon aggregation server and database 530 which stores the above-mentioned first result transmitted from the AI analytics server 540 by sorting the first result with a predetermined criteria (for example, by industries or sellers relevant to the analyzed coupons). The AI analytics server 540 in FIG. 8 performs a second analysis by the AI software 200 on the above-mentioned first result stored in the coupon aggregation server and database 530. The second result from the second analysis is mainly comprised of detailed coupon information 510, 511 as for respective coupons as shown in FIG. 6. Such second result will be clustered based on a predetermined criteria and stored in the AI coupon server and database 500.

To be clear, the above-mentioned first analysis or the second analysis may be performed by the AI tool (for example, the AI software 200) comprised of a language analysis tool such as the NLP tool 230 in FIG. 5, the image or video analysis too such as the computer vision tool 240 in FIG. 5, or any combination thereof.

If the AI coupon server and database 500 is dedicated to do all the AI analysis process depicted in FIG. 5, the smartphone 300 shown in FIG. 6 will become a client terminal, and the AI software 200 will be integrated into the AI coupon server and database 500. In this case, when the AI coupon server and database 500 receives a request from the client terminal 300 that needs to display the detailed coupon information 511, the AI coupon server and database 500 will be responsible for the transmission of the AI analysis result to the client terminal 300 so that the detailed coupon information 51, which is the above-mentioned second result of AI analysis, can be displayed with a proper user interface as described in FIG. 9 and more below on the client terminal 300.

Likewise, it is possible to partially utilize the memory or calculation capacity the smartphone 300 to relieve some burden for memory or calculation at the AI coupon server and database 500. Of course, even in this case, the smartphone 300 will be referred to as a client. Also, the memory space provided by the consumer smartphone 300 might be referred to as a computer (local) memory rather than a database because the AI coupon server and database 500 usually means a cloud storage at a database server accessible via a wired or wireless network as depicted in FIG. 6. Here, a memory means a local storage that stores the detailed coupon information 510 as a whole, and respective detailed coupon information 511 individually. Thus, any local storages employed in a consumer IT device 300 such as a PC or smartphone may correspond to a memory including both the main memory and secondary or temporary memory.

For reference, if the present invention is implemented in a way that the AI coupon server and database 500 is solely responsible for running the AI software 200 in FIG. 5, it would be preferable that the AI coupon server and database is equipped with one or more central processing units (CPU's), graphic processor units (GPU's), field programmable gate arrays (FPGA's), and various accelerator cards, considering a heavy burden for AI calculations about a bulk of coupons.

It should also be noted that the temporarily-deleted files (that is, files relevant to online or offline coupons 100, 110, 120, 130, 140, 150) that used to be accessible through a camera app of a smartphone 300 can still be subject to the analysis by the AI software 200 unless such image or video files regarding coupons have not been completely deleted from the device (or the cloud memory).

In summary, the data stored as text, image, video, or any combination thereof in the IT device (for example, the user smartphone 300), which can be processed for the AI analysis, may include an information about a sender of a marketing message to the IT device (or in some cases the SNS account holder 112 as shown in FIG. 2); an information about an app manager who sent an in-app marketing message to the IT device; or image or video files stored in or pending for deletion from the IT device by a camera function or a screen-recording function of the IT device, as noted above.

Referring to FIG. 6 again together with FIG. 5, the various AI tools such as the generative AI tool 210, ML tool 220, NLP tool 230, and computer vision tool 240 of the AI software 200 in FIG. 5 may work in parallel or in series to process the coupon data from, for example, a local storage medium (now shown) of the smartphone 300. In FIG. 6, the smartphone 300 saves the prepaid e-voucher 140, which can be used at a shop H SPA for a value of US$100, as well as the e-coupons 100, 130, SNS posting 110 having marketing information, and other various types of marketing means 150 comprised of text, image, and/or video. However, the smartphone 300 may save some simple text, image, or video files that might or might not be a “coupon.” Such files may be recognized as a coupon only after the AI software 200 finishes its analysis on those text, image, or video files.

As shown in FIG. 6, the data which turned out to be a coupon by the AI software 200 at the smartphone 300 will be transmitted to the AI coupon server and database 500. The AI coupon server and database 500 may save and handle all of the coupon-relevant data by itself, or, as explained above, may cooperate with the smartphone to relieve memory and CPU burdens required to process massive amount of coupon data. A unique coupon ID 511 will be attached to each and every coupon when the AI coupon server and database 500 saves each coupon data. Then, the AI analytics server 540 as will be described with reference to FIG. 8 may further analyze with the AI software 200 to extract detailed coupon information (for example, seller list that accepts the coupon, valid period, coupon-cash exchange rate, etc.) from respective coupons. The extracted result is saved in a memory space including the detailed coupon information 510 together with respective detailed coupon information and corresponding coupon ID 511. In the AI coupon server and database 500, it is possible to assign some label for coupon management to the coupon ID 511 and relevant coupon detailed information 510.

For reference, it is notable that the development process of the AI software 200 is generally comprised of stages of problem definition; data acquisition and preparation; model development and training; model evaluation and refinement; AI deployment on devices; and machine learning operation. These stages may be periodically or non-periodically but repeatedly performed, and thus, it is not preferable to assume that these stages are completely independent from each other. These stages are interconnected.

Because the present invention suggests that an image, video, or screen-capture file relevant to marketing should be recognized as a coupon though it is not a “traditional” e-coupon, even when the raw data 100, 110, 140, 150 in FIG. 6 is recognized and analyzed as a coupon in the coupon server and database 500, the analyzed result about the coupon recognition might be a first or preliminary analysis result. For example, the AI analytics server 540 in FIG. 8 might have to further perform a model analysis and particular correction procedures on such first or preliminary result. At the above-mentioned model evaluation and refinement stage of the AI software 200, various parameters of AI models might have to be adjusted, or the AI software 200 may ask the coupon server and database 500 to revisit the first analysis and delete “erroneous coupons” that turned out not to be a coupon in any way. That is, the procedures of AI coupon analysis in the present invention should be dynamically executed, and if necessary, the AI software may “revisit” the first analysis of coupon samples 100, 110, 120, 130, 140, 150 to filter out a piece of data which does not include any meaningful marketing information as an “erroneous coupon.”

Although not specifically shown in FIG. 6, it is preferable to include this revisiting process about the AI performance or analysis result in the present invention to increase the accuracy rate of AI coupon recognition, considering that non-traditional marketing means 110, 120, 140, 150 are analyzed by AI as well as traditional e-coupons 100, 130. Therefore, it would be possible to remove errors in the first result when re-analyzing the detailed coupon information 511 of each coupon to get the second AI analysis result.

Hence, the computer-implemented coupon management method of present invention may preferably include a step of optimizing the clustered result by removing from the coupon database (for example, the coupon aggregation server and database 530 in FIG. 8 below) or local memory such as a memory device (not shown) of a smartphone 300 memory one or more erroneous coupons that turned out not to include a marketing information which may be translated into the detailed coupon information during the clustering.

For instance, the prepaid gift voucher 140 in FIG. 6 is not very different from credit cards at first glance, however, the gift voucher 140 includes information about where to use or how much to use, printed on the surface of the gift voucher 140 in many cases. Thus, even if an image of a credit card or app card (which is not a coupon in any way) is wrongly stored in the coupon server and database 500 as if the credit card or app card is a coupon, while the AI software 200 tries to find the detailed coupon information such as information about where to use, how much to use, or how much to discount from the credit card image file, the AI software 200 may eventually determine that the credit card is not a coupon because no meaningful marketing information could be found. This trial-and-error (that is, revisiting and machine-learning process of AI) may be helpful in filtering out the credit card or app card image files from the outset in the future.

FIG. 7 shows an AI coupon advertisement system 800 according to one embodiment of the present invention. Referring to FIG. 7, the AI coupon advertisement system 800 according to one embodiment of the present invention is comprised of the AI coupon server and database 500. Of course, the AI coupon server and database 500, as a marketing agency, needs to interact with the seller or advertiser's terminal 400 and also with the client or consumer's terminal 300.

For reference, a terminology of computer, IT device, or terminal in the present invention may comprehensively mean any electronic devices such as a smartphone, smart pad, smart watch, notebook, PC, etc., and this terminology is identically applied to the advertiser terminal 400 and the client terminal 300. Likewise, the AI coupon server and database 500 can be referred to as a computer or IT device.

At step S1 in FIG. 7, the AI coupon server and database 500 receives e-coupons (for example, the e-coupon 100 as depicted in FIG. 1) from the advertiser terminal 400 as a marketing agency under an agreement about the advertising fees. At step S2, the AI coupon server and database 500 prepares a targeted advertising based on the request of the advertiser 400 and transmits the targeted e-coupon 100 a particular client terminal 300.

At step S3, the AI coupon server and database 500 interact with the client terminal 300 to collect various client data including some client profile information and coupon usage information. For example, if the AI coupon server and database 500 is in fact a search engine, the e-coupon 100 may be transmitted for a targeted coupon advertisement at step S2 based on coupon usage information, profile information, user account information, or user trait information already secured by the search engine thanks to this step S3 in the past. Thus, step S2 and step S3 may be performed in series, however, those two steps may be a mixture of continuous interactions between the AI coupon server and database 500 and the client terminal 300.

Next, at step S4 in FIG. 7, the AI coupon server and database 500 transmits a statistical data about the coupon usage and marketing performance to the advertiser terminal 400. According to the present invention, the AI coupon server and database 500 may correct the targeting criteria used at step S1 or may suggest a new or revised (or more appropriate) coupon advertisement created by the AI software 200 to the advertiser 400. Such suggestion of corrected targeting criteria or revised coupon may be done sometime after or simultaneously with the transmission of coupon usage statistics at step S4 in FIG. 7. Thus, the coupon advertisement sent by the advertiser terminal 400 at step S1 may be some AI-generated coupon (for example, see FIG. 15) which is not actually made by the advertiser 400. It can be understood that there exist another continuous interactions between the AI coupon server and database 500 and the advertiser terminal 400 in the AI coupon advertisement system 800 of the present invention.

FIG. 8 shows the AI coupon advertisement system 800 more in detail. Referring to FIG. 8, the AI coupon advertisement system 800 is comprised of the AI coupon server and database 500, which again is comprised of a coupon placement server 520; coupon aggregation server and database 530 that stores, for example, coupons 100, 130 and their detailed coupon information 510; and AI analytics server 540.

At step SS1 in FIG. 8, the advertiser terminal 400 sends digital advertisements such as the e-coupon 100 to the AI coupon server and database 500 to request for marketing agency. At step SS2, the coupon placement server 520 transmits digital advertisements such as the e-coupon 100 to the client terminal 300 which has been selected as a potential customer according to some predetermined coupon-targeting criteria.

If the client terminal 300 has shown frequent activities of accessing a particular app or website managed by a smartphone app developer or a SNS media company 600, the coupon placement server 520 may place the e-coupons 100, 130 somewhere at the smartphone app or SNS website under a separate agreement with the app developer or SNS company 600. In addition, as explained above, if the AI coupon server and database 500 runs its own search engine, the AI coupon server and database 500 may secure the “user tracking information” whenever the client terminal 300 interacts with information on the internet 700 at step SS3′ and then use such user tracking information at step SS2 for appropriate placement of advertisements or consumer profiling in the future ad-targeting process.

At step SS4 in FIG. 8, the coupon aggregation server and database 530 collects and stores, under the user's consent to privacy, the above-mentioned user tracking information or client tracking information, which is about a user's coupon usage history, whether the user used the coupon or not, app or web activities, etc., from the client terminal 300 and aggregates the advertising performances. The client tracking information collected and stored as in FIG. 8 is transmitted to the AI analytics server 540 at step SS5.

The AI analytics server 540 may be regarded as a physically or logically separated space where the AI software 200 of FIG. 5 operates, and also be a component processing the user profiling for targeted advertising and analysis on user traits. Preferably, the AI analytics server 540 will be equipped with high-end CPU, GPU, FPGA, and various accelerator cards to deal with complex AI calculations.

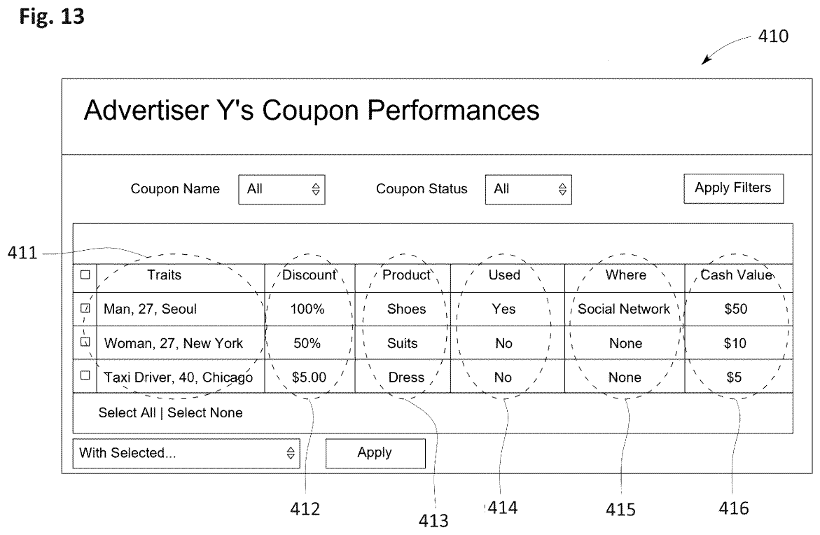

Meanwhile, at step SS6 in FIG. 8, the AI analytics server 540 corrects, supplements, or updates a coupon-targeting criteria or user profile information previously used by the coupon placement server 520, based on performance data of coupon advertising as depicted in FIG. 13. If the AI analytics server 540 doubts some possibility of error in the client tracking information collected by the coupon aggregation server and database 530 while analyzing coupon data, then the AI analytics server 540 may revisit such potentially erroneous information and feedback the result to the coupon aggregation server and database 530 so that the coupon aggregation server and database 530 may have a chance to correct some client tracking information and detailed coupon information 510 including files relevant to the coupons 100, 130, etc.

Although not shown in FIG. 8 but as explained above, the AI software 200 run by the AI analytics server 540 goes through multiple stages of problem definition; data acquisition and preparation; model development and training; model evaluation and refinement; AI deployment on devices; and machine learning operation. These stages may be periodically or non-periodically but repeatedly performed, and thus, it is not preferable to assume that these stages are completely independent from each other. These stages are interconnected. Therefore, the AI coupon analysis of the present invention should not be assumed to be exclusively done at the AI analytics server 540 or the AI coupon server and database 500. Rather, to increase the efficiency of the above-mentioned stages of AI, it would be also preferable to cooperate with some external third-party AI server (not shown) without physical limitations.

At step SS7 in FIG. 8, the AI analytics server 540 performs an analysis on whether the previous coupon-targeting criteria should be corrected; how to correct if required to do so; or whether the advertising coupon itself should be revised instead of modifying the coupon targeting criteria and transmits the “AI analysis result” to the coupon placement server 520. However, the process at step SS7 is not a unidirectional procedure. Rather, the coupon placement server 520 and AI analytics server 540 communicate with each other to gradually improve the accuracy rate of targeted advertising by exchanging important data such as current or previous client tracking information, AI analysis result, and coupon targeting criteria.

Afterwards, at step SS8 in FIG. 8, the coupon placement server 520 transmits to the advertiser terminal 400 some data about the advertisement performances as well as, if necessary, some new coupons (for example, coupons in FIG. 15 and FIG. 16) created and to be suggested by the AI analytics server 540. As noted above, such suggested AI coupons may be requested for next advertising by the advertiser 400 at step SS1. Thus, it can be reconfirmed that there exist continuous interactions between the AI coupon server and database 500 and the advertiser terminal 400.

Although not explicitly shown in FIG. 8, the AI software 200 in FIG. 5 may be installed on the client terminal 300 under the client's consent. The partial or complete installation of AI software 200 on the client terminal 300 may be useful in improving the accuracy of coupon targeting. As an example, the generative AI tool 210, ML tool 220, NLP tool 230 and computer vision tool 240 of the AI software 200 depicted in FIG. 5 may operate on the consumer's smartphone 300 in parallel or simultaneously with many other AI models at the coupon aggregation server and database 530 by sharing the coupon data stored in the smartphone 300 with the coupon aggregation server and database 530.

For reference, many marketing information formed as text, image, or video might not have been labeled and sorted as coupons on the client terminal 300. Furthermore, the advertiser 400 is likely not to have any idea about whether the client terminal 300 has the advertiser's marketing information distributed on a social network website (for example, as in FIG. 2) in the form of screen-captured image file, rather than downloading the same advertiser's e-coupon 100. Even in this scenario, according to the present invention, the AI software 200 installed on the client terminal 300 may automatically analyze and recognize such screen-captured image file as a coupon to send it to the coupon aggregation server and database 530 together with the client tracking information.

Now it can be understood that the AI-based coupon management system according to the present invention is comprised of a coupon server, which can be corresponding to a server function of the AI coupon server and database 500, performing a first analysis on a raw data stored as text, image, video, or any combination thereof in a client device (for example, the user smartphone 300) with an AI tool to automatically detect one or more coupons from the raw data and thereby obtain a first result; and a coupon database, which can be corresponding to a DB function of the AI coupon server and database 500, receiving and storing the first result from the coupon server. Here, the coupon server further performs a second analysis on the first result with the AI tool to extract a detailed coupon information from each of the detected coupons included in the first result and thereby obtain a second result comprised of the detailed coupon information so that the second result may be clustered and stored at the coupon database based on a predetermined criteria. Also, if the coupon server receives a client request to display the second result in part or as a whole for coupon management, the coupon server extracts from the coupon database a requested portion of the second result to send the requested portion to the client device as will be shown in FIG. 9 and more below.

FIG. 9 is a first exemplified user interface 310 to show how multiple coupons and their detailed coupon information (for example, 510 in FIG. 6) may be displayed to end users, for the purpose of the end users' coupon management according to one embodiment of the present invention.

As shown in FIG. 9, the respective detailed coupon information 511 among the collective detailed coupon information 510 may be clustered, for example, by industries such as airline 311, fashion 312, beverage 313, car 314, and the like so that the clustered data may be displayed with a proper UI on the consumer's smartphone 300. In addition, each coupon's identifier, and corresponding detailed coupon information 511 may be displayed as a list 315 as depicted on the right side in FIG. 9.

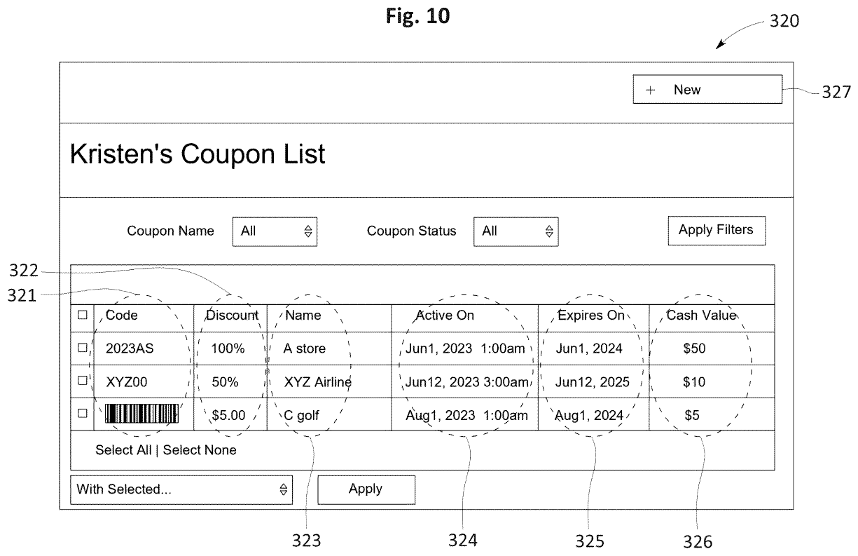

FIG. 10 shows a second exemplified user interface 320 to describe how respective detailed coupon information 511 may be displayed to end users. As shown in FIG. 10, the respective detailed coupon information 511 obtained by the AI analysis may be displayed on the end user's smartphone 300 according to various sorting criteria such as coupon code 321, discount rate 322, seller list 323 accepting each coupon, starting date 324 of each coupon, expiration date 325 of each coupon, coupon-cash exchange value 326, and so forth. It would be possible for the user to edit any contents of the UI 320 by clicking on the “add” or “new” button 327. Thus, in FIG. 10, information about a new coupon may be added, and some of the detailed coupon information may be deleted or edited as the user wants.

Again, as exemplified in FIG. 9 and FIG. 10, the detailed coupon information may include at least one of categories including the coupon name (for example, see 315 in FIG. 9), customer benefit (for example, see 322 in FIG. 10), valid period (for example, see 324 and 325 in FIG. 10), eligible use category (for example, see 311 to 314 in FIG. 9), eligible seller list (for example, see 323 in FIGS. 10 and 102 in FIG. 1), or equivalent value calculated by a predetermined criteria for each of the detected coupons (for example, refer to FIG. 11 and relevant descriptions below).

For reference, the seller list 323 accepting particular coupons may be the sender or publisher of the coupon in many cases and thus may be one of important index in the coupon analysis. As for the coupon code 321, a barcode or quick response (QR) code may be used instead of the combination of numbers and characters, as depicted in FIG. 10. For example, the code “2023AS” in FIG. 10 may have to be submitted to a seller's website through a particular window of the website to activate the discount benefit. In another case, the coupon publisher (for example, the advertiser terminal 400) may want to set up a policy to accept a barcode in lieu of such code input, which would not be something that can be controlled by the AI of the present invention.

A big difference between FIG. 10 and FIG. 9 is that respective detailed coupon information 511 included in the detailed coupon information 510 is not shown to the end users in FIG. 9, unlike the case in FIG. 10. Maybe the UI 310 in FIG. 9 can be a better UI than the UI 320 for a user who only wants to see and manage coupons with imminent expiration dates or wants to use an alert function of the smartphone 300 to know of such coupons with imminent expiration dates, while the UI 320 in FIG. 10 might be a better UI than the UI 310 for another user who wants to see and manage all types of marketing information stored in his or her smartphone 300 by a well-organized single chart for coupon management 320 including respective detailed coupon information 511.

To be clear, the detailed coupon information according to the present invention may include the valid period, and if that is the case, the present invention may preferably include a step of enabling the IT device (for example, the user smartphone 300) to set the above-described alert function to alarm an expiration of the valid period as for each or all of the detected coupons as organized in FIG. 9 or FIG. 10, based on the user request.

FIG. 11 shows a third exemplified user interface 330 to explain how multiple coupons and their detailed coupon information may be presented to end users according to one embodiment of the present invention.

In FIG. 11, the UI 330 indicates the cash value 332 of each coupon with the AI's automatic assumption that these coupons in FIG. 11 can be converted to cashes. For example, when an end user who is using six airline services 331 wants to find out which mileage program among those six airlines would be the most cost-effective mileage-ticketing option during a particular period of time, the UI 330 in FIG. 11 might be very useful for such end user. The coupon management screen 330 in FIG. 11 is composed of, for example, a first part 331 indicating respective airline service names and a second part 332 presenting the mileage or coupon versus cash exchange value as for those six airline services. In this case, the AI software 200 in FIG. 5 may preferably include mathematical or economic calculation tools or models (not shown).

In addition to the airline mileage as depicted in FIG. 11, shopping vouchers or coupons that can be used at a shop A Store or C Golf 323 in FIG. 10 may also be converted to the corresponding cash value 326. It should be noted that the cash value of coupons might change as time passes. Such change might be due to fluctuation of the currency exchange rate or price increase/decrease of goods in the market. In case of airline mileages, such change might be dependent on the coupon publisher's peculiar situations such as whether the flight should be scheduled in a high season, whether there is an abrupt flight cancellation, etc.

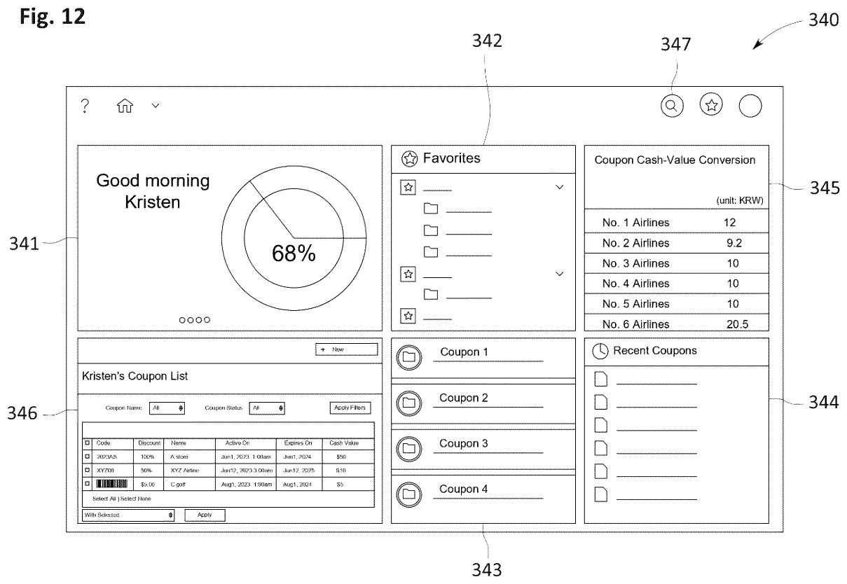

FIG. 12 is an example of a comprehensive user interface 340 according to one embodiment of the present invention, enabling the end users to efficiently manage heterogeneous multiple coupons with various use terms, valid periods, etc. on the end users' IT devices (for example, a consumer's smartphone 300) in an integrative way.

Referring to FIG. 12, the first part 341 of the UI 340 shows a coupon-usage rate among all the coupons that the end user currently has. Of course, it is feasible to modify the first part 341 to show, for example, the number of coupons that will expire in a week in comparison to the total number of coupons. The second part 342 of the UI 340 separately shows the coupon usage status of coupons that the end user prefers. The third part 343 may be designed with a list of coupons similarly to the UI 310 in FIG. 9.

The fourth part 344 shows several coupons that have been recently recognized as coupons by the AI software 200. The fifth part 345 may show a summary of the coupon management screen 330 in FIG. 11 if the user wants to review the cash value of airline mileages at a particular time period, as exemplified in FIG. 11. Also, if a user likes to review a screen like the detailed-style display 320 in FIG. 10 to know of respective detailed coupon information 511, the user may edit the sixth part 346 by the coupon management program of the present invention so that the sixth part 346 can be shown as a small-sized version of the UI 320 in FIG. 10. Meanwhile, the user of the UI 340 in FIG. 12 may user click on the search button 347 to search and find a coupon among many different coupons.

So far, the program and system for coupon management by using the IT devices have been disclosed with reference to FIG. 1 to FIG. 12. As described above, consumers could not fully enjoy the marketing benefits while sellers may not achieve sales increase that would be satisfactory in comparison to the sellers' marketing expenditures, because consumers or the end users of coupons did not have a proper tool to handle coupons, gift cards, membership programs, customer loyalty campaigns, or other similar online or offline marketing benefits. However, the present invention suggests that, by using the AI technology for managing coupons on smart devices, consumers may easily find out which coupons are necessary among so many different coupons. Also, consumers may administer a bulk of coupons with various techniques and interfaces. It is expected that such improved user experience for coupons, in return, might resolve the problem of low CVR on the seller side.

FIG. 13 is a first exemplified user interface 410 “for advertisers 400” which may be presented to advertisers 400 by the AI coupon advertisement system 800 according to one embodiment of the present invention.

The AI coupon server and database 500 secures clustered data about the detailed coupon information 411, 412, 413, 414, 415, 416, which may be automatically extracted for the review of advertisers 400 in the UI 410 of FIG. 13. Obviously, the detailed coupon information 411, 412, 413, 414, 415, 416 well-organized for advertisers 400 would be important basis for the advertisers' coupon targeting analysis including setting up a coupon targeting criteria.

Referring to FIG. 13, when an advertiser 400 asks the AI coupon server and database 500 to act as a marketing agency for a plurality of coupon advertisements, it would be conceivable that the advertiser 400 might want to know the marketing performances of individual coupons which have been systematically categorized with the coupon's ID number (for example, also see FIG. 6).

According to the AI coupon advertisement system 800 of the present invention, the advertiser 400 may easily review the entirety of its marketing strategy and advertising status with a single advertiser UI 410. The UI 410 includes consumer profile or trait information 411 used for targeted coupon advertising; discount rate information 412 designated by the advertiser 400 for each coupon; coupon-applicable product information 413 according to the advertising policy of the advertiser 400; information about “whether a coupon has been used” 414; information about “where a coupon has been placed” 415 (especially in a case where the advertiser 400 agreed with app developers or website managers 600 to provide coupon advertisements through the app or website); and coupon-cash exchange value 416 that was originally intended by the advertiser 400 or actually calculated by the AI software 200.

For reference, the coupon-cash exchange value 416 might be something that the advertiser 400 could not anticipate at the beginning. To feedback better insights to the advertiser 400, the AI analytics server 540 may independently calculate the coupon-cash exchange value 416 based on client tracking information. Particularly, when the AI coupon server and database 500 has, thanks to the client tracking information, some knowledge about average, lowest, or highest market price of a product similar to or same with the advertised product, the advertiser 400 may have a chance to know of the reality of coupon-cash exchange value (which might be a crucial factor for selecting coupons, for some consumers) by virtue of the automatic AI calculations in the present invention.

For instance, if a client terminal 300 has reported its web surfing history including websites of six different airline companies as client tracking information, the coupon-cash exchange value 416 may help an advertiser 400 compare the competitiveness of its current mileage program based on an assumption that some passengers might want to use the mileage program instead of buying flight tickets with cash.

As another example, if the client tracking information shows a fact that some other company's coupon has been used instead of the flight discount coupon requested by the advertiser 400, then the comparison of coupon-cash exchange value among coupons published by other flight companies might be helpful in understanding the reason why the flight discount coupon of the advertiser 400 was not selected by the consumer. Such understanding might provide the advertiser 400 with an insight for new marketing strategies to overcome the low CVR. In this case, as noted above, it would be preferable to include proper mathematical tools (not shown) in the AI software 200 of FIG. 5. Again, it should be noted that the cash value of coupons might change as time passes. Such change might be due to fluctuation of the currency exchange rate or price increase/decrease of goods in the market. In case of airline mileages, such change might be dependent on the coupon publisher's or the airline industry's peculiar situations such as whether the flight should be scheduled in a high season, whether there are abrupt flight cancellations, etc. Thus, the present invention might help an advertiser 400 understand the market changes and thereby analyze the appropriateness of its coupon marketing (for example, the amount of discount premium) on a real time basis.

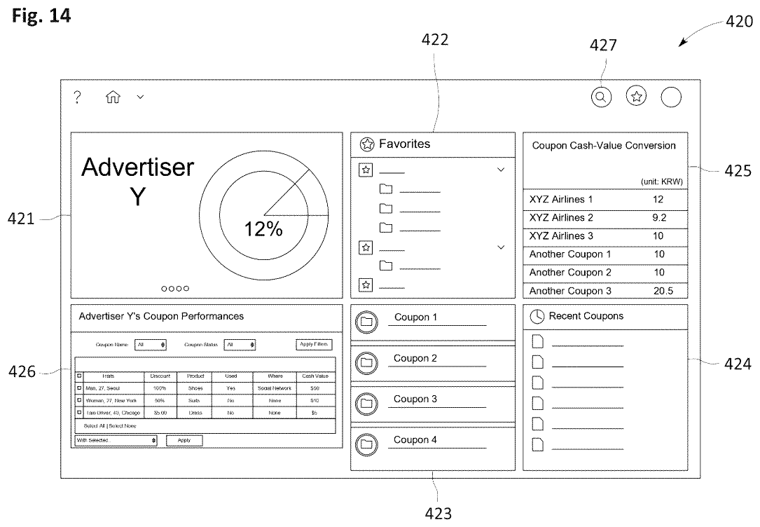

FIG. 14 is a second exemplified user interface 420 for advertisers 400 which may be presented to advertisers 400 by the AI coupon advertisement system 800 according to one embodiment of the present invention.

The advertiser UI 420 in FIG. 14 includes the first window 421 that visualizes marketing performances such as the coupon CVR of the advertiser 400. The second window 422 shows a list of coupons that the advertiser 400 frequently publishes and relevant usage status of those coupons. The third window 423 shows, for example, the coupons published by an advertiser Y. The fourth window 424 includes a list of coupons that the advertiser 400 recently asked for an agency's marketing, and the fifth window 425 shows an automatic analysis result of coupon-cash exchange values by comparing competitors' coupons with coupons published by the advertiser 400. The sixth window 426 is a small-sized version of the advertiser UI 410 depicted in FIG. 13. The search button 427 can be used when an advertiser 400 wants to find particular contents such as marketing performances of particular coupons; AI analysis result on a reason why some coupons have not been used; and recent coupon placement status.

In short, FIG. 14 shows a comprehensive interface 420 for the advertiser terminal 400 so that the advertiser 400 may efficiently and simultaneously manage heterogeneous multiple coupons with different use terms or valid periods, according to the present invention. To achieve this, as noted above, the AI analysis may be performed by a language analysis tool, image or video analysis tool, or any combination thereof. Of course, a step enabling the AI analysis to be done at the client terminals and receiving a result of such AI analysis from the client terminals may be included as well. Here, the detailed coupon information includes at least one of coupon name, customer benefit, valid period, eligible use category, eligible seller list, or equivalent value calculated by a predetermined criteria for each of the received e-coupons.

FIG. 15 is a third exemplified user interface 430 for advertisers 400 which may be presented to advertisers 400 so that they can review and choose e-coupons 431 revised by the AI coupon advertisement system 800 according to one embodiment of the present invention.

Basically, the advertisement strategy is implemented by the advertiser 400. The advertiser 400 is also responsible for making coupons and determining coupon policies such as which consumer group should be targeted as for the coupon; which product the coupon is applicable to; how to apply the discount rate; and how to accept the coupon (for example, letting the consumer submit the coupon to an offline staff or input the coupon's discount code at a website or some coupon-redemption window). Thus, step S1 in FIG. 7 or step SS1 in FIG. 8 is generally dependent on decisions of the advertiser 400.

However, the present invention suggests that the advertiser 400 may sometimes need the help of AI. That is, to improve the accuracy of coupon targeting, the AI technology might be used to correct the coupon targeting criteria that was initially set up by the advertiser 400 and even to make a revised e-coupon 431 in lieu of the original e-coupon (for example, 100 in FIG. 1) sent from the advertiser 400 based on a corrected coupon policy optimized by the AI software 200.

For example, the advertiser 400 initially may want consumers to use its fifteen (15) percent discount coupon at the advertiser's e-commerce website while the analysis of the client tracking information may suggest that some consumers prefer using coupons onsite to using coupons on the internet. In such cases, the AI coupon server and database 500 may suggest a different marketing approach to the advertiser 400 through the advertiser UI 430 in FIG. 15 by presenting several revised coupons 431 to the advertiser 400. Therefore, in some cases, the revised coupon 431 might be a coupon that can be used onsite with less discount rate (for example, 10%) in the above-mentioned scenario, as long as the AI determines that onsite coupons would yield better CVR even with such lowered discount rate. Thus, according to the present invention, the AI coupon server and database 500 may intervene in step S1 or step SS1 by means of the revised coupon 431.

FIG. 16 is a fourth exemplified user interface 440 for advertisers 400 which may be presented to advertisers 400 so that they can review and choose location-based e-coupons 441 created by the AI coupon advertisement system 800 according to one embodiment of the present invention.

The e-coupon 441 depicted in FIG. 16 is a location-based coupon created by the AI coupon advertisement system 800 and based on a corrected targeting criteria. Recently, consumers may use a location-based marketing app or augmented reality (AR) app that uses beacon network technology so that the consumers may instantly get coupon benefits by smartphones on a real time basis when entering a brick-and-mortar store. According to the present invention, while the revised coupon by AI can be literally a coupon with some revisions on the original coupon as in FIG. 15, the AI software 200 may go further to suggest the coupon placement strategy (for example, see 415 in FIG. 13) to achieve the most effective coupon targeting as shown in FIG. 16.

As explained above, the coupon placement server 520 and AI analytics server 540 may interact with each other to improve the targeting accuracy by exchanging important features for target marketing such as client tracking information, AI analysis information, and previous coupon targeting criteria used by the coupon placement server 520. After such interactions, if the AI software 200 determines that the physical location of a coupon will be the crucial factor to increase the CVR, then the advertiser 400 may receive unexpected feedback on its coupon advertisement strategy. That is, as exemplified in FIG. 16, the present invention may suggest a modified “where to use” condition of a “coupon with an e-map” 441 when the AI determines it is highly likely that the coupon in FIG. 16 can show the best CVR performance at the advertiser's branch store located on the third floor of the Seoul department store.

In short, one embodiment of the present invention may include a step creating one or more corrected e-coupons by a generative AI tool to feedback and suggest the corrected e-coupons to the advertiser terminals, for example, when it is determined that one or more compatible e-coupons have been used instead of the transmitted e-coupons.

So far, the computer-implemented method and system powered by AI for a targeted coupon advertising have been disclosed with reference to FIG. 7, FIG. 8, and FIG. 13 to FIG. 16. As discussed above, there was not a proper way to utilize AI to improve the coupon targeting criteria in the prior arts. However, a new advertisement system for coupon targeting according to the present invention uses AI technology so that the consumers may receive accurately-targeted coupons and the advertisers may overcome the low CVR issue and improve marketing performances against the marketing expenditures. In particular, the advertisers may manage a bulk of coupons with various user interfaces, and this might eventually provide the advertisers with some unexpected breakthroughs and insights for coupon marketing.

To be clear, the sever system powered by AI for a targeted coupon advertising according to the present invention may be comprised of a coupon advertisement server that receives e-coupons including respective detailed coupon information from the advertiser terminal 400. The coupon advertisement server will transmit the received e-coupons to client terminals based on a predetermined coupon-targeting criteria. Then, the server system may need a coupon advertisement database to collect and save coupon usage status (if coupons have been used) as well as some information about whether the transmitted e-coupons have been actually used at the client terminal. Again, the coupon advertisement server extracts from the coupon advertisement database the detailed coupon information, the coupon usage status, and pre-collected profile information of the client (or consumer) terminal to perform the AI analysis on the extracted data. The AI analysis result will be used to correct the above-mentioned predetermined coupon targeting criteria to generate a revised coupon targeting criteria as required, and then the coupon advertisement server will use the revised coupon targeting criteria under the advertiser's consent to further transmit the e-coupons to the client terminals. As mentioned above, the AI analysis may be performed by the AI tool (for example, the AI software 200) comprised of a language analysis tool such as the NLP tool 230 in FIG. 5, the image or video analysis too such as the computer vision tool 240 in FIG. 5, or any combination thereof. Furthermore, the sever system powered by AI may create one or more corrected e-coupons by a generative AI tool to feedback and suggest the corrected e-coupons to the advertiser terminals 400, for example, when it is determined that one or more compatible e-coupons of other competitor companies have been used instead of the transmitted e-coupons.

To describe the effect of the present invention more in detail, it should be noted that the AI software 200 generates a coupon database when recognizing coupons among the raw data comprised of text, image, and so on in the IT device. The raw data in the IT device might be a photo image taken at an offline store or from a billboard by a camera app of, for example, a smartphone. Of course, QR codes can be used to store such raw data. Even when some information relevant to promotions has been stored in the IT device as a picture, unbeknownst to the user, these information can also be included in the coupon database, which means that the consumers do not have to organize all the marketing benefits such as coupons or discount campaigns because the consumers now can access those marketing benefits in an organized and integrated way.

When the raw data about the marketing information is stored, then the AI may analyze the text, language, image, etc. to extract detailed coupon information such as valid period or use terms of individual coupons. The extracted information will be grouped and sorted according to a predetermined criteria so that, whenever the user wants to manage coupons, those extracted detailed coupon information can be instantly displayed to the consumer as the consumer wishes. During the extraction process, the coupon server and database may find errors and thus, the accuracy and integrity of the coupon database may be reconfirmed according to the present invention.

In addition, the coupon-cash exchange value may fluctuate according to current value of a currency, which might have important impact on the consumer's evaluation on the coupons. Thus, in the present invention, the consumer, not the seller, may have a chance to easily compare coupons to know which coupon applicable to identical items would be “better” coupon for the consumer by virtue of the coupon-cash exchange function of the present invention. The present invention not only deals with basic coupon information such as coupon usage information, but also enables an automatic management of coupons and their detailed information such as the coupon-cash exchange value.

According to the AI coupon management system of the present invention, the client terminal does not have to necessarily be involved in the complex AI calculations. The present invention may be implemented as an independent app providing user services for AI coupon management by using, for example, the cloud-based AI coupon server and database. Of course, it is possible to build a stand-alone AI analysis function running on the client terminal.

From the aspect of computer maintenances, it is possible to save power consumption and prevent the decrease of calculation capacity even in the massive coupon management because the user's IT device basically does not have to re-process the QR code or pictures taken at the offline stores as long as the IT device transmits the raw data to the AI coupon server and database.

With respect to the aspect of the targeted advertising, the advertisement server of the present invention receives coupon advertisements from the advertiser and then transmits coupons to multiple targeted-clients. Because the advertisement server or the AI coupon server and database may collect a client tracking information including the actual coupon usage history or whether those coupons have been used at the client terminal, the AI coupon server and database may perform an AI analysis on the detailed coupon information of used or unused coupons and coupon usage history together with pre-collected client profile information to improve the targeting accuracy by correcting the initial coupon-targeting criteria based on the AI analysis result.

That is, the present invention presumes that there can be situations where the CVR of the targeted coupons turned out not to be satisfactory to the advertiser's expectations even if the advertiser prepared a thorough client profiling and trait analysis before executing the coupon campaigns. Therefore, since the present invention suggests a way for the advertiser to correct the initial targeting criteria, the marking performance of targeted coupon advertising may be gradually improved.

Moreover, the present invention tries to capture the reason why some targeted coupons of the advertiser have not been used during the above-mentioned AI analysis. In other words, if it is turned out that the e-coupons requested by the advertiser were not used while similar e-coupons of other competitor companies have been used, the AI coupon server and database may suggest corrections of the original coupons to the advertiser by virtue of the generative AI tool based on the client tracking information. In turn, the advertiser may have a chance to revisit the appropriateness of its coupon campaigns (for example, whether the text of coupon was proper, whether the coupon-targeting was accurate, whether the valid period or use condition was appropriate, etc.) from the outset and improve marketing strategies in the future.

The AI coupon server and database may utilize the client tracking information collected under the consumer's consent to perform better AI analysis. It is expected that such feature of the present invention may contribute to build a positive ecosystem for targeted coupon advertisement. That is, when the marketing information originally formed with the text, image, or video at the client terminal may be automatically recognized as coupons by the AI, the consumer's coupon-use experience might be improved and convenient, and this may in return contribute to more precise AI analysis in the future to eventually overcome the low CVR issues.

As noted above, the detailed coupon information includes at least one of coupon name, customer benefit, valid period, eligible use category, eligible seller list, or equivalent value calculated by a predetermined criteria for each of the detected coupons. Thus, such detailed coupon information may provide an improved marketing insight for advertisers. In short, the advertisers may understand why the coupon has been use or why the coupon has not been used with the help of AI inferences to set up a better targeting advertisement next time.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

For example, in FIG. 7, the AI software 200 operates on the smartphone 300, and the AI coupon server and database 500 may receive the coupon analysis result through wired or wireless network from the smartphone 300 whenever required. However, as noted above, some or all functions of the AI software 200 may be performed in conjunction with a third-party's AI server (not shown). In this case, the smartphone 300 might only be used to display various UI's shown in FIG. 9 to FIG. 16. Likewise, although the AI software 200 operates at the AI analytics server 540 in FIG. 8, the client terminal 300 may perform at least some functions of the AI software 200 and communicate with the AI coupon server and database 500 so that the overall system may yield more accurate and meaningful coupon analysis results including client tracking information and coupon use information under the consumers' consent.

In addition, even when the AI software 200 is implemented as a stand-alone program running on the smartphone 300, the training stage of the AI software may be still performed with a bulk of third-party's training data, without having to solely rely on several coupon samples 100, 110, 120, 130, 140, 150. That is, the concept of AI training procedure does not have to be limited to a particular physical space.

To be clear, the method of the present invention may be in the form of computer program by a machine language and such program may be stored in a computer-readable storage medium to be used for managing multiple coupons by an IT device. A first analysis on a raw data stored as text, image, video, or any combination thereof in the IT device may be performed by a programmed command in the storage medium with an AI tool to automatically detect one or more coupons from the raw data. The result of the first analysis is treated as the detected coupons that will be stored in a coupon database or a local memory according to relevant computer commands. A second analysis on the coupon database or local memory is performed with the AI tool to extract a detailed coupon information from each of the detected coupons. The detailed coupon information corresponding to each of the detected coupons is clustered based on one or more predetermined criteria and stored as the clustered result in the coupon database or local memory. Finally, the detailed coupon information selected from the clustered result according to a user request of the IT device will be displayed for coupon management by virtue of the computer program stored in the computer-readable storage medium.

Likewise, a computer-implemented method at a server side for managing multiple e-coupons for targeted advertising may also be in the form of computer program by a machine language and such program may be stored in a computer-readable storage medium. By means of commands of such computer program, at the server side, a first step receiving e-coupons, each including a detailed coupon information, for the targeted advertising from one or more advertiser terminals may be performed. The next step would be a second step transmitting the received e-coupons to one or more client terminals based on a predetermined coupon-targeting criteria. A third step is performed by the computer command to collect information on whether the transmitted e-coupons have been used by the client terminals; and coupon use details as for the used e-coupons. A fourth step performing an AI analysis on the detailed coupon information and the coupon use details together with a pre-collected profile information of the client terminals and a fifth step creating a new coupon-targeting criteria other than the predetermined coupon-targeting criteria to reflect a result of the AI analysis for the targeted advertising in the future will be performed afterwards. Then, a sixth step repeating the second to fifth steps after transmitting the received e-coupons to the client terminals based on the new coupon-targeting criteria is included in the present invention. Thus, the computer-implemented method of the present invention may be stored in any computer-readable medium for AI coupon target marketing.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

What is claimed is:

1. A computer-implemented method for managing multiple coupons by an information technology (IT) device, comprising:
performing a first analysis on a raw data stored as text, image, video, or any combination thereof in the IT device with an artificial intelligence (AI) tool to automatically detect one or more coupons from the raw data, and thereby store the detected coupons in a coupon database or a local memory;
performing a second analysis on the coupon database or local memory with the AI tool to extract a detailed coupon information from each of the detected coupons;
clustering the detailed coupon information corresponding to each of the detected coupons based on one or more predetermined criteria, and storing a clustered result in the coupon database or local memory; and
displaying the detailed coupon information selected from the clustered result according to a user request of the IT device for coupon management.

2. The method of claim 1, wherein the first analysis or the second analysis is performed by the AI tool comprised of a language analysis tool, image or video analysis tool, or any combination thereof.

3. The method of claim 1, further comprising:
optimizing the clustered result by removing from the coupon database or local memory one or more erroneous coupons that turned out not to include a marketing information which may be translated into the detailed coupon information during the clustering.

4. The method of claim 1, wherein the detailed coupon information includes at least one of coupon name, customer benefit, valid period, eligible use category, eligible seller list, or equivalent value calculated by a predetermined criteria for each of the detected coupons.

5. The method of claim 4, further comprising:
if the detailed coupon information includes the valid period, enabling the IT device to set an alert function to alarm an expiration of the valid period as for each or all of the detected coupons based on the user request.

6. The method of claim 1, wherein the data stored as text, image, video, or any combination thereof in the IT device may include an information about a sender of a marketing message to the IT device; an information about an app manager who sent an in-app marketing message to the IT device; or image or video files stored in or pending for deletion from the IT device by a camera function or a screen-recording function of the IT device.

7. An artificial intelligence (AI)-based coupon management system comprising:
a coupon server performing a first analysis on a raw data stored as text, image, video, or any combination thereof in a client device with an AI tool to automatically detect one or more coupons from the raw data and thereby obtain a first result; and
a coupon database receiving and storing the first result from the coupon server,
wherein the coupon server further performs a second analysis on the first result with the AI tool to extract a detailed coupon information from each of the detected coupons included in the first result and thereby obtain a second result comprised of the detailed coupon information so that the second result may be clustered and stored at the coupon database based on a predetermined criteria; and
wherein, if the coupon server receives a client request to display the second result in part or as a whole for coupon management, the coupon server extracts from the coupon database a requested portion of the second result to send the requested portion to the client device.

8. A computer-implemented method at a server side for managing multiple e-coupons for targeted advertising, comprising:
a first step receiving e-coupons, each including a detailed coupon information, for the targeted advertising from one or more advertiser terminals;
a second step transmitting the received e-coupons to one or more client terminals based on a predetermined coupon-targeting criteria;
a third step collecting information on whether the transmitted e-coupons have been used by the client terminals; and coupon use details as for the used e-coupons;
a fourth step performing an artificial intelligence (AI) analysis on the detailed coupon information and the coupon use details together with a pre-collected profile information of the client terminals;
a fifth step creating a new coupon-targeting criteria other than the predetermined coupon-targeting criteria to reflect a result of the AI analysis for the targeted advertising in the future; and
a sixth step repeating the second to fifth steps after transmitting the received e-coupons to the client terminals based on the new coupon-targeting criteria.

9. The method of claim 8, wherein the fourth step further includes a step creating one or more corrected e-coupons by a generative AI tool to feedback and suggest the corrected e-coupons to the advertiser terminals when it is determined that one or more compatible e-coupons have been used instead of the transmitted e-coupons.

10. The method of claim 8, wherein the AI analysis may be performed by a language analysis tool, image or video analysis tool, or any combination thereof; and wherein the third step includes a step enabling the AI analysis to be done at the client terminals and receiving a result of such AI analysis from the client terminals.

11. The method of claim 8, wherein the detailed coupon information includes at least one of coupon name, customer benefit, valid period, eligible use category, eligible seller list, or equivalent value calculated by a predetermined criteria for each of the received e-coupons.
